(19) United States
(12) Patent Application Publication
(10) Pub. No.: US 2007/0036960 A1
(43) Pub. Date: Feb. 15, 2007

(54) Film and methods of making film

(76) Inventors: William Scott Lambert, Moore, SC (US); Sonya Wolters, Boiling Springs, SC (US); Lee Rieth, Spartanburg, SC (US); Darin L. Dotson, Moore, SC (US); Pedro Van Hoecke, Spartanburg, SC (US); Christopher S. Kerscher, Greenville, SC (US)

Correspondence Address: Legal Department;M-495, PO Box 1926, Spartanburg, SC, 29304, US

(21) Appl. No.: 11/199,642

(22) Filed: Aug. 9, 2005

(51) Int. Cl. B32B 27/32

(52) U.S. Cl. 428/220

(57) ABSTRACT

A film article comprising a polyethylene polymer or copolymer and a cycloaliphatic metal salt is disclosed. A method of making a blown and a cast polyethylene film is shown. The film may also include various additives that are employed to improve the properties of the film, including stearate-containing compounds. Additives employed in one embodiment of the invention may reduce the percent haze of film formed in the process, thereby providing desirably low levels of haze. Zinc stearate is one additive that can be employed in making a low haze polyethylene film.

### BACKGROUND OF THE INVENTION

Polymer compositions may be rendered molten for manufacture into a wide variety of articles. Such articles may include films, fibers, and tubes. Various polymer processing techniques are known, including extrusion, blowing, molding, compression, and injection, in which the molten polymer is cooled and shaped into a solid mass. Each process has its own particular physical and chemical effects upon the polymer. Further, each process is customized to achieve exactly the performance required from the polymer, using the least amount of energy, and at the maximum rate of production. In general, the use of one compound or formula in one type of polymer processing technique does not predict success using the same formula in another type of processing technique. Extensive trial and experimentation is needed to determine that a particular formulation is or is not suitable for a particular type of polymer process.

Thermoplastic compositions must exhibit certain physical characteristics to facilitate widespread use. Specifically within polyolefins, for example, uniformity in arrangement of crystals upon crystallization is sometimes necessary to provide an effective, durable, and versatile polyolefin article. To achieve desirable physical properties, certain compounds and compositions can be employed to provide nucleation sites for polyolefin crystal growth during molding or fabrication. Nucleating agents are known to modify the crystalline structure of thermoplastic polymers.

The use of nucleating agents may increase the temperature and the rate of crystallization. Compositions containing such nucleating compounds crystallize at a much faster rate than non-nucleated polyolefins. Crystallization at higher temperatures results in reduced fabrication cycle times and a variety of improvements in physical properties such as stiffness.

Nucleating agents provide nucleation sites for crystal growth during cooling of a thermoplastic molten formulation. The presence of such nucleation sites results in a larger number of smaller crystals. As a result of the smaller crystals formed therein, clarification of the target thermoplastic may be achieved. However, excellent clarity is not always a result. The more uniform (and smaller) the crystal size, the less light is scattered. Thus, the clarity of the thermoplastic article itself may be improved. Thus, thermoplastic nucleator compounds are important to the industry, as they may provide enhanced clarity, improved physical properties and faster processing.

Dibenzylidene sorbitol derivatives are nucleator compounds, commonly used in polypropylene end-products. Compounds such as 1,3-O-2,4-bis(3,4-dimethylbenzylidene)sorbitol (hereinafter DMDBS), available from Milliken Chemical under the trade name Millad® 3988, provide excellent nucleation and clarification characteristics for polypropylene.

Other well known nucleator compounds include sodium benzoate, sodium 2,2′-methylene-bis-(4,6-di-tert-butylphenyl)phosphate (from Asahi Denka Kogyo K.K., known as “NA-11™”), aluminum bis[2,2′-methylene-bis-(4,6-di-tert-butylphenyl)phosphate] (also from Asahi Denka Kogyo K.K., known as “NA-21™”), and talc.

U.S. Pat. Nos. 6,599,971 and 6,562,890 each disclose using metal salts of hexahydrophthalic acid (HHPA) in polypropylene (PP) to provide desirable properties in polypropylene. U.S. Pat. No. 6,562,890 teaches, for example, the extrusion of disodium HHPA salts with calcium stearate in polypropylene homopolymer in an extrusion process. Extrusion of polypropylene is followed by injection molding, to form polypropylene 50 mil PP plaques. A Killion single screw extruder is used in the process. The polypropylene is passed through an extruder die, according to the examples of the reference. Lithium stearate was used as an acid scavenger in some polypropylene samples which were passed through an extruder die in the disclosed extrusion process.

U.S. Pat. No. 6,599,971 discloses various HHPA compounds used in polypropylene (PP) homopolymer and molded into plaques by melt compounding on a Killion single screw extruder through an extruder die. The performance of various HHPA compounds were measured in molded polypropylene plaques as stated in the reference, using acid scavengers such as calcium stearate and lithium stearate. This patent also discloses the nucleation of polyester polymer.

Extrusion of polymer is a common manner of making extruded plastic articles. Other processes, however, are known for processing polymers. Processing techniques, temperatures, and the like vary greatly among various types of polymer processing techniques. In general, it is not predictable or certain that any particular formulation used in one type of processing (such as extrusion) could apply or work in a different type of polymer processing technique, using different temperatures, mechanical processing methods, cure times and the like. Further, each type of polymer itself provides unique properties, and it is not predictable that an additive or procedure used with one type of polymer would perform satisfactorily with another polymer.

### BRIEF DESCRIPTION OF THE DRAWINGS

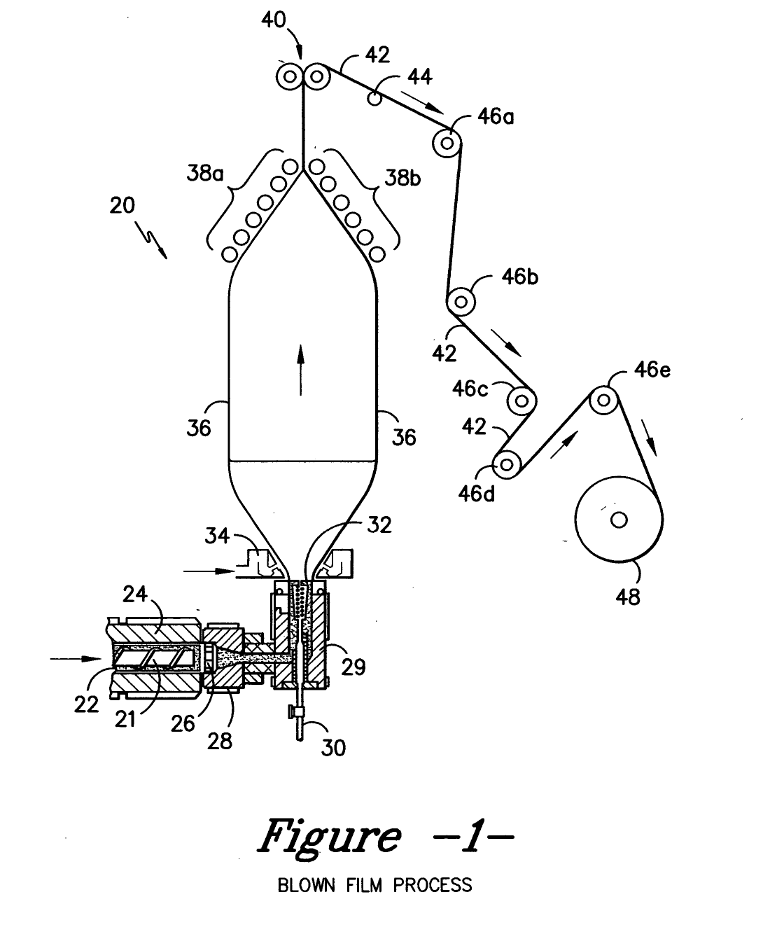

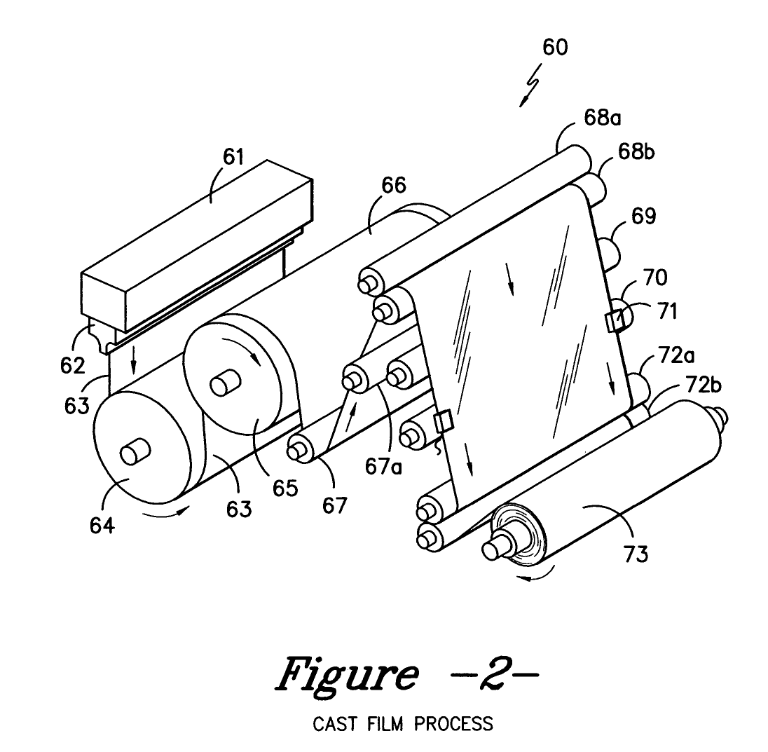

A full and enabling disclosure of this invention, including the best mode shown to one of ordinary skill in the art, is set forth in this specification. FIG. 1 is a schematic showing a blown film extrusion process as may be applied in the invention. FIG. 2 shows a cast film process, as further described herein.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

Polyethylene film is one type of film that finds particular application in the industry. In the past, polyethylene film has provided relatively poor optical properties due to haze in the polyethylene films. It is desirable in the polyethylene film industry to reduce the haze and improve the optical clarity of such films, while maintaining or improving the physical properties of the film. This invention is directed at improved polyethylene film, and methods of making improved polyethylene-based films.

Surprisingly, it has been discovered that employment of certain additives in polyethylene with particular cycloaliphatic salt nucleating agents may improve the properties of a film made with such polyethylene. Use of fatty acid salts as co-additives with such nucleating agents provides benefits in the manufacture of film. Such fatty acid salts may include stearates of zinc, calcium, lithium, magnesium or sodium. Zinc stearates may be particularly advantageous in the practice of the invention. In the invention, an additive package comprising at least one cycloaliphatic salt nucleating agent with a co-additive of a fatty acid salt (with a C₁₂-C₂₂ anion and a cation) is employed. The cation may be zinc, calcium, sodium, lithium, magnesium and others employed in the fatty acid salt. The invention may be applied in polyethylene of various densities, as further described herein.

When using a nucleator of a cycloaliphatic salt, a hexahydrophthalic acid (HHPA) salt compound may be employed in one particular embodiment of the invention. This compound employs a counter-ion, including, for example, a calcium counter-ion. Calcium has been found to be particularly effective in providing a low degree of haze, as compared to other counter-ions, when employed with a co-additive fatty acid salt.

A combination of a fatty acid salt of a C₁₂-C₂₂ anion and a cation of certain specific metals may provide enhanced clarity and reduced % haze. Metals of zinc, calcium, sodium, lithium, magnesium and others may be used in such a fatty acid salt. Results with zinc have been found to be particularly good. A calcium-containing nucleating agent compound and zinc stearate co-additive has been found to provide very favorable properties in blown film. Such films provide reduced % haze, while maintaining and in some instances even enhancing physical properties of the film.

In the practice of the invention, it has been found that polyethylene density ranges of between about 0.910 and about 0.965 grams/cc are quite useful. Further, in other applications, linear low density ranges of about 0.910-0.940 grams/cc are employed. Still other applications of the invention may employ higher density polyethylene in the range of about 0.940 to about 0.965 grams/cc.

Definitions

1. “Cycloaliphatic metal salt” refers to a compound having a non-aromatic cyclic carbon ring structure and a metal ion as a counter ion, to form an ionic salt.
2. “Polyethylene polymer or copolymer” refers to essentially any type of polyethylene (“PE” or “PE film”), including (for example) Ziegler Nafta and/or metallocene catalyzed polyethylenes, also known as homogeneously catalyzed PEs.
3. “Film” for purposes of this specification refers to an article made by, but not limited to: blown, cast, orientation, or coating processes. The typical thicknesses of films made in the film making processes are 250 micron or less, and in some instances, 75 microns or less.
4. The term “blown film” refers to a film made according to the process shown and described in connection with FIG. 1 and the discussion herein relating to FIG. 1. It may also include processes termed in the industry as “double bubble” processes.
5. The term “dicarboxylate” refers to an organic metal salt that is derived from a dicarboxylic acid; that is, a compound having two carboxylic acid entities on the molecule. This may include, but is not limited to, the following illustrative example. 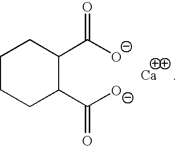
6. The term “thermoplastic” is intended to mean a polymeric material that will melt upon exposure to sufficient heat and will subsequently solidify, upon sufficient cooling. This term can include both semi-crystalline and amorphous polymers. Particular types of polymers contemplated within such a definition that may be applied in the practice of the invention include, without limitation, polyolefins (such as polyethylene, polypropylene, (syndiotactic or isotactic) polybutylene, and any combination thereof), polyamides (such as nylon), polyurethanes, polyesters (such as polyethylene terephthalate), copolymers of said polymers, and the like, as well as any combinations thereof.
   Further Properties of the Enhanced Film of the Invention

Improvements in optics and physical properties made possible by the invention may lead to enhancements in packaging operations and packaging performance. For example, improved modulus and stiffness is a desired property in packaging operations, as it enhances the speed and quality of the operation. Improved optics of the package is desired to improve the shelf appeal of the film or package. Improved optics is desired without the loss of other physical properties. Packaging operations that may benefit from the improved physical properties practiced in the invention include, but are not limited to Horizontal Form Fill and Seal, Vertical Form Fill and Seal, Bag Making, Film Wrapping Operations, Forming Films, lidstocks, and pouches. Multi-layer constructions may also benefit from the use of this invention.

The invention in one application employs the addition of cycloaliphatic metal salts with a polyethylene polymer or copolymer to form films having improved properties. In one particular embodiment of the invention, the fatty acid salt comprises an anion and a cation, the anion of the fatty acid salt comprising at least one C₁₈ (stearic) hydrocarbon chain.

In other more specific embodiments of the invention, it may be possible to use various hexahydrophthalate (HPPA) salt compounds compounds similar to that shown in such film articles:

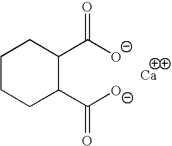

A blown film article further may comprise or include a C₁₂-C₂₂ fatty acid compound, such as for example, a stearate-type compound. Furthermore, the cycloaliphatic metal salts may comprise dicarboxylate salts, as above, including a carbocyclic ring structure, and a cation or metal.

A blown film may be made which is less than about 250 microns in thickness. In other applications, a film may be made which is less than about 75 microns in thickness, or in some instances, less than about 25 microns. A blown film article is particularly useful in the practice of the invention, but other types of film manufacturing processes also can be employed.

In one application of the invention, a film is made comprising a polyethylene polymer or copolymer and a cycloaliphatic metal salt, wherein said cycloaliphatic salt further comprises a compound conforming to Formula (I) 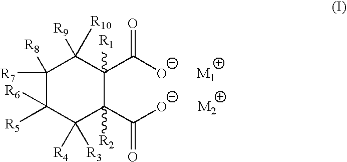
wherein M₁ and M₂ are independently selected from calcium, strontium, lithium, zinc, magnesium, and monobasic aluminum;
wherein R₁, R₂, R₃, R₄, R₅, R₆, R₇, R₈, R₉, and R₁₀ are independently selected from the group consisting of: hydrogen and C₁-C₉ alkyls;
further wherein any two adjacently positioned R₃-R₁₀ alkyl groups optionally may be combined to form a carbocyclic ring.
   In this application of the invention, it is possible, but not required, that each of R₁, R₂, R₃, R₄, R₅, R₆, R₇, R₈, R₉, and R₁₀ comprise hydrogen. Further, M₁ and M₂ may be combined as a single calcium ion.

One method of practicing the invention may comprise the steps of: (a) providing a polyethylene polymer or copolymer; (b) blending said polyethylene polymer or copolymer with a cycloaliphatic metal salt to form blended polyethylene material; (c) plowing said blended polyethylene material; and(d) forming a film.

In the practice of the invention, films can be made by several different means: blown, cast, oriented, and be either monolayer or co-extruded films, having polyethylene as the only component or as one of many components in the monolayer or co-extruded film.

An acid scavenger compound may be applied in the method prior to the blowing step (c). An acid scavenger compound employed in such a method may comprise essentially any fatty acid salt, including for example a stearate, such as for example zinc stearate. Zinc stearate has been shown to provide surprisingly beneficial results, as shown in examples herein.

In the method, one may employ a dicarboxylate salt comprising one or two cations, at least one of said cations being calcium.

Compounds and compositions comprising specific metal salts of hexahydrophthalic acid (HHPA) in order to provide highly desirable properties within thermoplastic articles are provided. The inventive HHPA derivatives are useful as nucleating and/or clarifying agents for such thermoplastics, are practical and easy to handle. Such compounds, when added to the thermoplastic provide good (and sometimes excellent) crystallization temperatures, stiffness, and acid scavenger compatibility.

The term polyolefin or polyolefin resin as used herein is intended to encompass any materials comprised of at least one semicrystalline polyolefin. Examples include polyethylene, isotactic and syndiotactic polypropylene, poly(4-methyl)pentene, polybutylene, and any blends or copolymers thereof, whether high or low density in composition. The polyolefin polymers of the present invention may include aliphatic polyolefins and copolymers made from at least one aliphatic olefin and one or more ethylenically unsaturated co-monomers.

### Synthesis of Cycloaliphatic Metal Salts

In the practice of the invention, it is possible to make the cycloaliphatic salts that may be applied in the invention, according to the synthesis procedure set forth in U.S. Pat. No. 6,562,890 (column 7, Examples 1 and 2). Calcium HHPA (or other HHPA's) can be made in a manner similar to that shown in U.S. Pat. No. 6,562,890 for Cis-disodium HHPA, as recognized by a person of skill in the art.

### Manufacture of Blown Film

Referring to FIG. 1, a blown film may be manufactured. Blown film extrusion 20 is shown in FIG. 1. A molten polymer or resin 22 is made by beginning with a compounded resin (as described in Examples herein), wherein the compounded resin contains various additives as set forth, including nucleating agents, acid scavengers, and the like. Molten polymer or resin 22 is pushed by screw 21 from left to right as shown in FIG. 1, and along the direction of the arrow. Molten polymer 22 passes through screen pack 26, and is heated by heater 28. In other instances, heaters may be provided along the entire length of the extruder block 24. The molten polymer 22 passes through die 29, and beyond mandrel 32. Air line 30 provides compressed air to blow said molten polymer 22 into a blown polymer bubble 36 beyond air ring 34. The air ring 34 controls the cooling of the polymer bubble 36 to make film 42 which is formed. The blown polymer bubble 36 is circular (or tubular), and is seen in a side view in FIG. 1. The ejection of air against the polymer to form a tubular shaped “bubble” of polymer is referred to herein as “blowing” the polymer, and the polymer proceeds upwards as shown in FIG. 1.

The bubble 36 is tube shaped, and is cooled to below T_{c}, crystallization temperature. Then, the polymer is rolled into a flattened tube or wound. The blown polymer bubble 36 passes by guide rolls 38a-b, and through nip rolls 40. The bubble 36 is sealed by nip 40, and thus air cannot easily escape. The bubble 36 acts like a permanent shaping mandrel once it has been injected. The bubble 36 becomes a film 42 that may be passed over a treater bar 44 and rolled among various guide rolls 46a-e to wind-up roll 48. Orientation in the machine direction (i.e. the direction of travel) can be induced by tension from the nip rolls 40.

### Manufacture of Cast Film

In the practice of the invention, it also may be possible to make cast film using the novel compositions disclosed herein. Cast film may be made using techniques known in the cast film manufacturing industry, and the invention may apply equally as well to cast film forming techniques. A cast film may be manufactured in which the film comprises a polyethylene polymer or copolymer; and a cycloaliphatic metal salt; and a fatty acid salt, said fatty acid salt having an anion of C₁₂-C₂₂ and a cation, in which the cation is selected from the group consisting of: zinc, calcium, lithium, magnesium and sodium.

Referring to FIG. 2, a cast film process 60 is shown. A molten polymer emerges from extruder 61 at die 62 in the form of a hot film 63. This hot film 63 is made with a compounded resin (as described in Example herein), wherein the compounded resin contains various additives as set forth, including nucleating agents, acid scavengers, and the like. The molten polymer passes through die 62, forming a sheet or film 63 and then is “cast” as a sheet onto chill rolls 64 and 65 to cool and crystallize into cooled film 66. In many instances, the film 63 will pass over a series of chill rolls in order to fully cool and crystallize the polymer to a temperature below Tc, crystallization temperature. The film 66 then may be passed along idler rolls 67 and 67a and between nip rolls 68a-b to powered carrier rolls 69-70. The film may be passed over a treater bar (not shown) and then slit at trimmer 71. The edges of the film 66 are trimmed off by a trimmer as the edge of the film may be of a different thickness than that desired. Trimming also allows for control of the film roll width before passing to nip rolls 72a-b and windup roll 73. The film is wound upon windup roll 73 for storage and transport. Cast and blown film processes obviously differ by the geometry and equipment with which films are made, as shown in a comparison of FIGS. 1 and 2. These Differences in mode of extrusion result in differences in the cooling and deformation modes of each type of film, resulting in differences in molecular orientation and thus physical properties of each of the films. The cast film process typically cools at a faster rate than the blown film process resulting in a differences in crystallinity between the two film types. Differences in crystallinity will result in differences in the optical and physical properties between the cast and blown film types. The cast film process produces film having primarily a uniaxial deformation mode, meaning that molecular orientatiori is primarily in a single direction (referred to herein as “uniaxial molecular orientation”). The blown film process has a biaxial orientation deformation mode, resulting in biaxial molecular orientation. Differences in molecular orientation result in differences in the physical properties of each of the films. Physical property differences can be seen in such properties as modulus and impact properties.

### EXAMPLE 1

### Calcium HHPA in LLDPE

To a common Linear Low Density Polyethylene (LLDPE) in the film industry and having a density of 0.917 grams per cubic centimeter, a mixture of 1000 ppm of the following Calcium HHPA compound was applied:

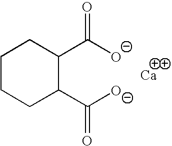

The above compound and a standard stabilization package (500 ppm Irganox® 1010, 1000 ppm Irgafos 168, and 800 ppm zinc stearate) were also added to the formulation. The resulting mixture was physically blended, twin screw compounded, and pelletized. The resultant compounded resin was then made into film of 25 micron in thickness using a standard blown film process with a blow up ratio of 2.5. The resultant film had the following properties:

TABLE I
Physical Properties of LLDPE Blown Film

| | Yield | Break | | 1% Secant | | Dart |
|---|---|---|---|---|---|---|
| | Stress | Stress | % Elongation @ | Modulus | Elmendorf | Impact |
| Sample | (psi) | (psi) | Break | (psi) | Tear (g) | (g) |
| ASTM | D882 | D882 | D882 | D882 | D1922 | D1709 |
| Method | | | | | | |
| Control | 1523/1523 | 2858/2336 | 526/579 | 19.9/23.7 | 373/547 | 340 |
| Clarified | 1610/1741 | 2727/3003 | 480/664 | 24.1/30.5 | 246/490 | 192 |

Values are Given as Machine Direction/Transverse Direction

TABLE II
Optical Properties of LLDPE Blown Film

| Sample | % Haze | 60° Gloss |
|---|---|---|
| Control | 13.2 | 80 |
| Clarified | 6.3 | 113 |

### EXAMPLE 2

### CALCIUM HHPA in MDPE

To, a common MDPE in the film industry, having a density of 0.934 grams per cubic centimeter, a mixture of 1000 ppm of Calcium HHPA and a standard stabilization package (500 ppm Irganox® 1010, 1000 ppm Irgafos 168, and 800 ppm zinc stearate) were added. The resulting mixture was physically blended, twin screw compounded, and pelletized. The compounded resin was then formed into film of 25 micron in thickness using a standard blown film process with a blow up ratio about 2.5.

The resultant film had the following properties:

TABLE III
Physical Properties of MDPE Blown Film

| | Yield | Break | % | 1% | | |
|---|---|---|---|---|---|---|
| | Stress | Stress | Elongation | Secant | Elmendorf | Dart Impact |
| Sample | (psi) | (psi) | @ Break | Modulus | Tear (g) | (g) |
| ASTM Method | D882 | D882 | D882 | D882 | D1922 | D1709 |
| Control | 2394/2466 | 3580/3027 | 476/589 | 45.2/48.3 | 43/331 | 76 |
| Clarified | 2481/2771 | 3246/2690 | 404/534 | 48.4/61.7 | 27/338 | <70 |

Values are Given as Machine Direction/Transverse Direction

TABLE IV
Optical Properties of MDPE Blown Film

| Sample | % Haze | 60° Gloss |
|---|---|---|
| Control | 18.1 | 50 |
| Clarified | 8.3 | 114 |

### EXAMPLE 3

### CALCIUM HHPA in Various Types of Polyethylene

To several types of polyethylene (PEs), a mixture of 1000 ppm of Calcium HHPA and a standard stabilization package (500 ppm Irganox® 1010, 1000 ppm Irgafos® 168, and 800 ppm zinc stearate) were added. The resulting mixtures were physically blended, single screw compounded, and pelletized. The resultant compounded resin was then made into film of approximately 50 micron in thickness using a standard blown film process with a blow up ratio of approximately 2.0. The resultant films had the following optical properties:

TABLE V
Optical Properties of PE Having Different Comonomer Types
and Catalysts

| | Resin Density | | Clarified % |
|---|---|---|---|
| Resin | (g/cc) | Control % Haze | Haze |
| LLDPE #1 | 0.918 | 23.6 | 11.6 |
| LLDPE #2 | 0.917 | 23.7 | 11.5 |
| LLDPE #3 | 0.920 | 25.7 | 9.5 |
| LLDPE #4 | 0.920 | 25.4 | 10.6 |

### EXAMPLE 4

### Optical Properties of LLDPE Films of Varying Thickness

To a common LLDPE in the film industry a mixture of approximately 1000 ppm of Calcium HHPA and a standard stabilization package (500 ppm Irganox® 1010, 1000 ppm Irgafos 168, and 800 ppm zinc stearate) were added. The resulting mixture was physically blended, single screw compounded, and pelletized. The resultant compounded resin was then made into film of varying thicknesses using a standard blown film process. The resultant film had the following properties, for both clarified and unclarified film percent haze:

TABLE VI
Optical Properties of LLDPE/CalciumHHPA/Zinc Stearate

| | Unclarified Film % | |
|---|---|---|
| Film Thickness (mil) | Haze | Clarified Film % Haze |
| 1.8 | 30 | 16 |
| 3.0 | 37 | 15 |
| 5.6 | 51 | 25 |

### EXAMPLE 5

### Optical Properties of LLDPE Films Using Various Clarifiers

To a common LLDPE in the film industry, a mixture of various potential clarifiers and a stabilization package (500 ppm Irganox® 1010, 1000 ppm Irgafos 168, and 800 ppm zinc stearate) were added. The resulting mixtures were physically blended, single screw compounded, and pelletized. The resultant compounded resins were then made into film of approximately 2 mil thickness using a standard blown film process. The resultant film had the following properties:

TABLE VII
Nucleating Agent Type versus Haze and Clarity

| | Additive | | |
|---|---|---|---|
| | Concentration | | |
| Additive | (ppm) | % Haze | Clarity |
| Control | 0 | 50.4 | 90.5 |
| Millad 3940 | 1000 | 19.7 | 69.6 |
| NA-11 | 1000 | 27.8 | 98.3 |
| NA-21 | 1000 | 36.7 | 96.4 |
| Sodium Benzoate | 1000 | 46.1 | 90.0 |
| Potassium | 1000 | 50.3 | 90.9 |
| dehydroabietate | | | |
| CALCIUM | 1000 | 20.8 | 99.1 |
| HHPN/ZnSt | | | |

### EXAMPLE 6

### WVTR of Clarified Resins

To a common LLDPE in the film industry a mixture of 1000 ppm of Calcium HHPA and a standard stabilization package (500 ppm Irganox® 1010, 1000 ppm Irgafos 168, and 800 ppm zinc stearate) were added. To a common MDPE in the film industry (density=0.934 g/cc), a mixture of 1000 ppm of Calcium HHPA and a standard stabilization package (500 ppm Irganox®) 1010, 1000 ppm Irgafos 168, and 800 ppm zinc stearate) were added. The resultant compounded resin was then made into film of 25 micron in thickness using a standard blown film process with a blow up ratio of 2.5.

Water Vapor Transmission Rate (WVTR) was then measured using ASTM F 372-94. The results are shown in the table below.

TABLE VIII
Water Vapor Transmission of Manufactured Films

| | Unclarified Film WVTR | Clarified Film WVTR |
|---|---|---|
| Resin | (g mil/100 in² day) | (g mil/100 in² day) |
| MDPE | 1.152 | 0.851 |
| LLDPE | 0.864 | 0.476 |

### EXAMPLE 7

### Effect of HHPA Counter Ion on Optical Properties of LLDPE Films

To a common LLDPE in the film industry a mixture of HHPA salt and a stabilization package (500 ppm Irganox® 1010, 1000 ppm Irgafos 168, and 800 ppm zinc stearate) were added.

The type of HHPA salt was varied as a function of its counter ion. The counter ions included Zinc, Sodium, Lithium, Calcium, and Magnesium. The resulting mixtures were physically blended, single screw compounded, and pelletized. The resultant compounded resins were then made into film of approximately 50 micron thickness using a standard blown film process.

Haze was measured according to ASTM D 1003 (“Standard Test Method for Haze and Luminous Transmittance of Transparent Plastics”), Procedure A. This testing procedure employs a hazemeter as described in Section 5 of ASTM D 1003, and is considered an industry standard for such measurements.

Surprisingly, the calcium counter ion showed substantially improved % Haze levels as compared to other counter ions. This is an unexpected result, and very beneficial.

The resultant films had the following properties:

TABLE IX
Zinc Stearate Employed with Various HHPA SALTS

| HHPA SALT | % Haze | Clarity % |
|---|---|---|
| NONE | 50.4 | 90.5 |
| Zinc HHPA | 50.9 | 88.0 |
| Calcium HHPA | 20.4 | 99.4 |
| Magnesium HHPA | 37.3 | 94.1 |
| Lithium HHPA | 53.3 | 84.0 |

### EXAMPLE 8

### Effect of Acid Scavenger Type Upon Optical Properties of LLDPE Films

To a common LLDPE in the film industry a mixture of (1000 ppm) Calcium HHPA and a stabilization package (500 ppm Irganox® 1010, 1000 ppm Irgafos 168, and 800 ppm of an acid scavenger) were added. The type of acid scavenger was varied to include Zinc Stearate (ZnSt), Calcium Stearate (CaSt), and Sodium Stearate (NaSt). The resulting mixtures were physically blended, single screw compounded, and pelletized. The resultant compounded resins were then made into film of approximately 2 mil thickness using a standard blown film process. It was surprisingly discovered that the use of ZnSt provided unexpected and significant benefits in % Haze as compared to the other stearate compounds tested. The resultant films had the following properties:

TABLE X
Comparison of Different Stearates With Calcium HHPA

| Acid Scavenger | % Haze | Clarity |
|---|---|---|
| No Clariifier, ZnSt | 50.4 | 90.5 |
| CaHHPA + ZnST | 20.4 | 99.4 |
| CaHHPA + CaST | 26.1 | 98.8 |
| CaHHPA + NaST | 26.2 | 98.5 |

### EXAMPLE 9

### Effect of CaHHPA in Polyethylene Made by Cast Film Process

To a common LLDPE in the film industry (density=0.917 g/cc) a mixture of 1000 ppm of Calcium HHPA and a stabilization package (500 ppm Irganox® 1010, 1000 ppm Irgafos 168, and 800 ppm of an acid scavenger) were added. The resulting mixture was physically blended, single screw compounded, and pelletized. The resultant compounded resin was then made into film of approximately 25 micron thickness using a standard cast film process. The resultant films had the following properties.

TABLE XI
Clarification of LLDPE in the Cast Film Process

| Resin | Unclarified Film % Haze | Clarified Film % Haze |
|---|---|---|
| LLDPE | 10.5 | 7.4 |

### EXAMPLE 10

### Effect of Calcium HHPA in HDPE

To a common HDPE in the film industry and having a density of 0.958 grams Ic per cubic centimeter, a mixture of Calcium HHPA (1000 ppm) and a stabilization package (500 ppm Irganox® 1010, 1000 ppm Irgafos 168, and 800 ppm of an acid scavenger) were added. The resulting mixtures were physically blended, single screw compounded, and pelletized. The resultant compounded resins were then made into film of approximately 2 mil thickness using a standard blown film process. The resultant films had the following properties.

TABLE XII
Clarification of HDPE

| Resin | Unclarified Film % Haze | Clarified Film % Haze |
|---|---|---|
| HDPE | 58.4 | 51.6 |

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A blown film comprising:
(a) a polyethylene polymer or copolymer, said polymer or copolymer having a density between about 0.910 and about 0.965 grams/cc and a biaxial molecular orientation, and
(b) a cycloaliphatic metal salt.

2. The blown film of claim 1, wherein said blown film further comprises:
(c) a fatty acid salt.

3. The blown film of claim 2, wherein said fatty acid salt comprises an anion of C₁₂-C₂₂ and a cation, said cation being selected from the group consisting of the following: zinc, calcium, lithium, magnesium and sodium.

4. The blown film of claim 3 wherein said cation comprises zinc.

5. The blown film of claim 1 wherein said cycloaliphatic metal salt further comprises a compound conforming to Formula (I) 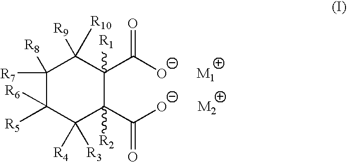
wherein M₁ and M₂ are independently selected from the group consisting of: calcium, strontium, lithium, zinc, magnesium, and monobasic aluminum;
further wherein R₁, R₂, R₃, R₄, R₅, R₆, R₇, R₈, R₉, and R₁₀ are independently selected from the group consisting of: hydrogen and C₁-C₉ alkyls; further wherein any two adjacently positioned R₃-R₁₀ alkyl groups optionally may be combined to form a carbocyclic ring.

6. The blown film of claim 5 wherein M₁ and M₂ are present collectively as one or more calcium ions.

7. The blown film of claim 5 wherein said blown film provides a % haze measured according to ASTM D 1003 of less than about 26% @ a blown film thickness of 2 mils.

8. The blown film of claim 1, wherein said film is less than about 3 mils in thickness.

9. A blown film comprising:
a polyethylene polymer or copolymer having biaxial molecular orientation and a density between about 0.910 and about 0.965 grams/cc; and
a dicarboxylate metal salt of the structure:

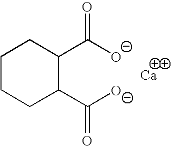

10. The blown film of claim 9, said blown film further a fatty acid salt.

11. The blown film of claim 10, said fatty acid salt further comprising at least one stearate-containing compound.

12. The blown film of claim 11 wherein said said density of said polyethylene polymer or copolymer is further defined in the range of about 0.940 to about 0.965 grams/cc.

13. The blown film of claim 11 wherein said polyethylene density is further defined in the range of between about 0.910 and 0.940 g/cc.

14. The blown film of claim 11 wherein said stearate-containing compound comprises zinc stearate.

15. A method for preparing a blown film, said method comprising the steps of:
(a) providing a polyethylene polymer or copolymer having a biaxial molecular orientation and a density in the range of from about 0.910 to about 0.965 grams/cc;
(b) heating said polyethylene polymer or copolymer;
(c) blending said polyethylene polymer or copolymer with at least one cycloaliphatic metal salt to form a blended polyethylene material;
(d) blowing said blended polyethylene material; and
(e) forming a blown film.

16. The method of claim 15, wherein zinc stearate is applied into said blended polyethylene material prior to said blowing step.

17. The method of claim 15, comprising the additional step of:
(f) forming said blown film into a product by employing at least one of the following: horizontal form fill operations, vertical form fill and seal, bag making, film wrapping operations, forming films, lidstocks, and pouches.

18. The method of claim 15, wherein said blowing step employs a blow ratio of about 2.5.

19. The method of claim 15, wherein said film formed is equal to or less than about 3 mils in thickness.

20. A method for preparing a blown film, said method comprising the steps of:
(a) providing a polyethylene polymer or copolymer having a density in the range of between about 0.910 and about 0.940 grams/cc;
(b) heating said polyethylene polymer or copolymer;
(c) blending said polyethylene polymer or copolymer with a dicarboxylate cycloaliphatic metal salt, said dicarboxylate cycloaliphatic salt having at least one calcium ion, said salt having the following structure: 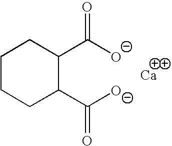
thereby forming a blended polyethylene material;
(d) blowing said blended polyethylene material; and
(e) forming a film having reduced amounts of haze.

21. The method of claim 20, wherein zinc stearate is applied into said blended polyethylene polymer prior to said blowing step.

22. A blown film comprising:
a polyethylene polymer or copolymer; and
a cycloaliphatic metal salt; and
a fatty acid salt, said fatty acid salt having an anion of C₁₂-C₂₂ and a cation, said cation being selected from the group consisting of: zinc, calcium, lithium, magnesium and sodium;
further wherein said blown film provides a Water Vapor Transmission Rate (WVTR) of less than 0.9 g mil/100 in² day.

23. A cast film comprising:
(a) a polyethylene polymer or copolymer having substantially uniaxial molecular orientation, said polyethylene polymer or copolymer having a density of between about 0.910 and 0.965 grams/cc; and
(b) a cycloaliphatic metal salt.

24. The cast film of claim 23, said cast film further comprising:
(c) a fatty acid salt.

25. The cast film of claim 24, said fatty acid salt further comprising an anion of C₁₂-C₂₂ and a cation, said cation being selected from the group consisting of: zinc, calcium, lithium, magnesium and sodium.

26. The cast film of claim 25, wherein said cation comprises zinc.

27. An additive package adapted for application to a polymer in the manufacture of a blown film, said additive package comprising;
a cycloaliphatic metal salt; and
a fatty acid salt, said fatty acid salt having an anion of C₁₂-C₂₂ and a cation, said cation being selected from the group consisting of: zinc, calcium, lithium, magnesium and sodium.

28. The additive package of claim 27 wherein said anion of said fatty acid salt comprises at least one C₁₈ (stearic) hydrocarbon chain.

29. The additive package of claim 27 wherein said cation comprises zinc.

30. The additive package of claim 27 wherein said fatty acid salt comprises zinc stearate.
